(19) United States
(12) Patent Application Publication
(10) Pub. No.: US 2010/0239327 A1
(43) Pub. Date: Sep. 23, 2010

(54) DEVELOPING DEVICE, IMAGE FORMING DEVICE AND IMAGE FORMING METHOD

(75) Inventors: Yoichi YAMADA, Shiojiri-shi (JP); Tomohiro ARUGA, Matsumoto-shi (JP); Daisuke MATSUMOTO, Matsumoto-shi (JP); Atsunori KITAZAWA, Shiojiri-shi (JP); Masaru KOBASHI, Matsumoto-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/724,890

(22) Filed: Mar. 16, 2010

(30) Foreign Application Priority Data
Mar. 23, 2009 (JP) 2009-070844

(51) Int. Cl. G03G 15/08

(52) U.S. Cl. 399/284

(57) ABSTRACT

A development device includes a housing having toner housed therein; a toner carrying roller that has a plurality of convex portions and concave portions surrounding the convex portions, formed on a surface thereof; and a conductive restriction blade in which a free end or an adjoining region adjacent to the free end abuts the surface of the toner carrying roller, thereby restricting the amount of the toner carried on surface of the toner carrying roller, wherein the toner has an external additive including a metal oxide, the restriction blade is applied with a restriction bias voltage of the same polarity as the regular electrification polarity of the toner, and a gap between the front end of the free end and the convex portion of the toner carrying roller is smaller than a volume average particle diameter of the toner.

### BACKGROUND

1. Technical Field

The present invention relates to a developing device having a toner carrying roller in which a convex portion and a concave portion are arranged on its surface, an image forming device and an image forming method for forming an image using the roller.

2. Related Art

In the technique for developing an electrostatic latent image by means of toners, generally, the toners are carried on a surface of a toner carrying roller formed approximately in the cylindrical shape. In this type of technique, since there is an unavoidable fluctuation in electrification amounts of the toners, in particular, the toner having a low electrification amount and the toner electrified with the polarity opposite to the original electrification polarity are attached to a portion of the image to which the toner should not be naturally attached, leading the so-called fogging. Thus, in order to increase the electrification amount of the toner carried on the toner carrying roller surface, there is a certain configuration in which conductive toners are used as the toners and at the same time an electric charge injection member, which was applied with a bias voltage having the same polarity as the electrification polarity of the toner, is opposed to the toner carrying roller to provide the toner of the toner carrying roller surface with the electric charge (for example, JP-A-2005-331780, FIG. 1).

However, according to the experiment by the inventors of the present invention, in the technique described in JP-A-2005-331780, since an electric field due to the bias voltage applied to the electric charge injection member acts in a direction that pushes the previously electrified toner toward the toner carrying roller side, the toner transporting amount on the toner carrying roller is increased. As a result, the amount of toner to which the electric charge should be injected is increased and the overall electrification amount is increased, but an effect of suppressing the fluctuation in the electrification amount of each of the toners is insufficient.

### SUMMARY

An advantage of some aspects of the invention is to suppress the fluctuation in the electrification amounts of the toner on the toner carrying roller to suppress the fogging, in a developing device having the toner carrying roller in which a convex portion and a concave portion are arranged on the surface thereof, an image forming device and an image forming method for an image using the roller.

The developing device relating to one embodiment of the invention includes a housing having a toner housed therein, a toner carrying roller which is pivoted to the housing, has a plurality of convex portions that form one portion of a cylindrical face in which each upper face is identical to each other and concave portions surrounding the convex portions are formed on the surface thereof, and rotates while carrying the electrification toner supplied from the housing on the surface, and a conductive restriction blade in which a free end faces a rotating direction upstream of the toner carrying roller and at the same time the free end or an adjoining region adjacent to the free end contacts the toner carrying roller, thereby restricting the amount of the toner carried on surface of the toner carrying roller, wherein the toner has an external additive including a metal oxide, the restriction blade is applied with a restriction bias voltage having the same polarity as the regular electrification polarity of the toner, and a gap between the front end of the free end and the convex portion of the toner carrying roller is smaller than a volume average particle diameter of the toner.

Further, the image forming device according to another embodiment of the invention includes a housing with a toner housed therein, a toner carrying roller which is pivoted to the housing, has a plurality of convex portions that forms one portion of a cylindrical face in which each upper face is identical to each other and concave portions surrounding the convex portions are formed on the surface thereof, and rotates while carrying the electrification toner supplied from the housing on the surface, a conductive restriction blade in which a free end faces a rotating direction upstream of the toner carrying roller and at the same time the free end or an adjoining region adjacent to the free end contacts the toner carrying roller, thereby restricting the amount of the toner carried on surface of the toner carrying roller, a bias application unit for applying a predetermined restriction bias voltage to the restriction blade, a latent image carrier which is arranged opposite to the toner carrying roller and carries an electrostatic latent image on its surface, wherein the toner has an external additive including a metal oxide, the restriction bias voltage has the same polarity as the regular electrification polarity of the toner, and a gap between a front end of the free end and the convex portion of the toner carrying roller is smaller than a volume average particle diameter of the toner.

Further, an image forming method according to another embodiment of the invention includes carrying a toner on a surface of a toner carrying roller which has a plurality of convex portions that form one portion of a cylindrical face in which each upper face is identical to each other and concave portions surrounding the convex portions are formed on the surface thereof, contacting a conductive restriction blade in which a free end faces a rotating direction upstream of the toner carrying roller and at the same time the free end or an adjoining region adjacent to the free end contacts the toner carrying roller surface, thereby restricting the amount of the toner, and opposing a latent image carrier which carries an electrostatic latent image to the toner carrying roller to develop the electrostatic latent image by the toner, the toner having an external additive including a metal oxide, the restriction blade being applied with the restriction bias voltage having the same polarity as the regular electrification polarity of the toner, a gap between a front end of the free end and the convex portion of the toner carrying roller being smaller than a volume average particle diameter of the toner.

In these embodiments of the invention, firstly by contacting the restriction blade with the toner carrying roller surface and making the gap (hereinafter, referred to as an opening height) between the front end of the free end of the restriction blade and the convex portion of the toner carrying roller less than the volume average particle diameter of the toner, the toner carried on the convex portion is restricted to be less than one layer. Further, since the gap between the front end of the restriction blade and the concave portion is regulated by regulating the opening height as above, an amount of the toner carried on the concave portion is also substantially restricted to become regular. Thus, the amount of the toner carried on the toner carrying roller can be almost mechanically regular, regardless of the bias application to restriction blade. This effect can be obtained by adopting the toner carrying roller having a structure that forms one portion of the cylindrical face in which the upper faces of the convex portions are identical to each other. As described above, since the toner amount is mechanically restricted, in the embodiments of the invention, the restriction bias voltage having the same polarity as the regular electrification polarity of the toner is applied to the conductive restriction blade.

Although it will be described in detail later, as a result of various experiments preformed by the present inventors, in an electrification mechanism in which the toner is electrified by contacting the conductive member applied with bias to provide the electric charge, no matter what the conductivity the toner has as described in JP-A-2005-331780, there was obtained knowledge that a presence of the toner of a particular external additive provided on the toner surface greatly contributes to the electrification of the toner. Concretely, in the toner in which minute particles of a suitable amount of metal oxide are provided as external additives, by injecting the electric charge from the conductive member provided with an electric potential of the same polarity as the regular electrification polarity thereof into the metal oxide external additive of the toner surface, regardless of the conductivity of the toner base particle itself, it is possible to effectively control the electrification amount of the overall toners.

Thus, in the embodiment of the invention, by adopting the toners provided with the metal oxide external additives and the toner carrying roller in which the height of the convex portion upper face is managed, and by mechanically managing the amount of the toner carried on its surface by the restriction blade, the amounts of the toners transported into a nip portion that is formed by contact of the toner carrying roller and the restriction blade are managed. In addition, by applying the restriction bias voltage having the same polarity as the regular electrification polarity of the toner to the restriction blade, the toner transported to the nip portion is provided with the electric charge to control the electrification amount thereof. As a result, in the embodiment of the invention, it is possible to effectively suppress a problem in which the toner with insufficient electrification amount is separated from the toner carrying roller and scatters or is attached to an image to cause fogging.

In the embodiments of the invention, the gap between the front end of the free end and the convex portion of the toner carrying roller may be 0. Namely, the restriction in which the front end of the restriction blade comes into direct contact with the convex portion of the toner carrying roller, that is to say, an edge restriction may be used. In this manner, the toner is not mostly carried on the convex portion. The toner having low electrification amount among the toners carried on the convex portion is easily scattered by a wind pressure caused by the rotation of the toner carrying roller. In the embodiments of the invention, while the electrification amount is increased by providing the toner thinly attached to the convex portion with the electric charge from the restriction blade and the scattering hardly occurs by making separation from the toner carrying roller surface difficult, as a result, the toner of the convex portion does not contribute so much to an improvement of the development concentration. Thus, from the viewpoint that the scattering and the fogging are reliably suppressed and the toner carrying amount in the concave portion is more exactly controlled, the toner carrying on the convex portion may be eliminated.

Further, it is desirable that the toner contains at least one of titanium oxide, aluminum oxide, zinc oxide, cerium oxide or tin oxide, as the metal oxide. With regard to these metal oxides, it was confirmed by the experiments of the inventors that the electrification amount control by the structure of the embodiments of the invention functions effectively.

Further, both contact toner that comes in direct contact with the toner carrying roller surface and non-contact toner that does not come in direct contact with the toner carrying roller surface may be carried on the concave portion. The contact toner that comes in direct contact with the toner carrying roller surface in the concave portion is electrostatically securely attached to the toner carrying roller surface originally having a high electrification amount. On the other hand, the non-contact toner that does not come in direct contact with the toner carrying roller surface has a low electrification amount and is carried so as to cover the contact toner layer attached to the toner carrying roller surface. As described above, the toner having low electrification amount can become a cause of the scattering and the fogging, but since the toner carried on the concave portion retreated from the convex portion surface is hardly subject to wind pressure, the scattering is suppressed. Further, in a system with only the contact toner carried thereon, because almost all the toners come in contact with the restriction blade, the electrification amount is liable to be excessive, and since this causes the attachment force of the toner to the toner carrying roller to increase, there is no problem from the viewpoint of the suppression of the scattering and the fogging, but it is disadvantageous from the viewpoint of obtaining the high developing concentration.

Further, since the electric charge is applied only to the non-contact toner exposed to the surface side when the restriction blade applied with bias comes in contact with the toner layer of the concave portion, it is possible to increase the electrification amount of only the non-contact toner. On the other hand, the electrification amount of the contact toner originally having the high electrification amount is not excessively increased. Further, with regard to the non-contact toner with high electrification amount, since the restriction bias voltage acts so as to generate a repulsive force, the excessive voltage is also suppressed. As a result, the electrification amount only the toner with low electrification amount among the toners carried on the concave portion is increased and the fluctuation in the electrification amounts becomes small, thereby suppressing the occurrence of the fogging.

Concretely, for example, the gap between the front end of the free end and the concave portion of the toner carrying roller may be one time larger than the volume average particle diameter of the toner. In this way, the toner layers exceeding one layer are carried on the concave portion, and as a result, both the contact toner and the non-contact toner are included. Further, when the number of toner layers carried on the concave portion is high, the non-contact toner that cannot come in contact with the restriction blade appears in the non-contact toners. Since this toner becomes a cause of the fogging, in order to reliably supply the non-contact toner with the electric charge, it is desirable that the number of layers be two layers or less. Namely, it is desirable that the gap between the front end of the restriction blade and the concave portion be twice the volume average particle diameter of the toner or less.

Further, the toner carrying roller may be made of a metal in which the surface is subject to amorphous plating treatment. In this toner carrying roller, it is clarified by the experiments of the inventors that the toners can be satisfactorily frictionally electrified in the housing. By combining this toner carrying roller with the restriction blade applied with the restriction bias voltage, the properties of the toners carried on the toner carrying roller surface are satisfactorily maintained and an excellent image quality can be obtained.

Further, it is desirable that the content rate of the metal oxide as the external additive in the toner be 0.5% by weight or more. When the addition amount of the metal oxide external additive is too small, the electrification control effect of the embodiments of the invention is slight, according to the experiment of the inventors, it is desirable that the metal oxide of more than at least 0.5% by weight be added. In particular, in the toner in which other external additives with a high insulation property such as silica and resin beads were added, it is effective when the amounts of the metal oxide external additives are made to be larger.

### BRIEF DESCRIPTION OF THE DRAWINGS

The invention will be described with reference to the accompanying drawings, wherein like numbers reference like elements.

FIG. 1 is a diagram illustrating one embodiment of an image forming device to which the present invention is applied.

FIG. 2 is a block diagram illustrating an electric structure of the image forming device in FIG. 1.

FIG. 3 is a diagram illustrating an appearance of a developer.

FIGS. 4A and 4B are diagrams illustrating a construction of the developer and a development bias waveform.

FIG. 5 is a partly enlarged view of a development roller and its surface.

FIG. 6 is a diagram illustrating the profile of the experiment executed by the inventors.

FIGS. 7A and 7B are diagrams illustrating evaluation results of fogging amount and development concentration by the toner properties.

FIG. 8 is a diagram illustrating the measurement results of the fogging amount when the restriction bias voltage is changed.

FIGS. 9A to 9D are model diagrams illustrating the behaviors of the toner in the concave portion.

FIG. 10 is a model diagram illustrating the development in FIG. 9 more microscopically.

FIGS. 11A to 11C are model diagrams illustrating the development in FIG. 10 even more microscopically.

FIGS. 12A and 12B are diagrams illustrating the modified example in which the toner carrying is allowed in the convex portion.

FIGS. 13A-13C are diagrams illustrating the measurement result of the properties of the toner layer under the different restriction condition.

### DESCRIPTION OF EXEMPLARY EMBODIMENTS

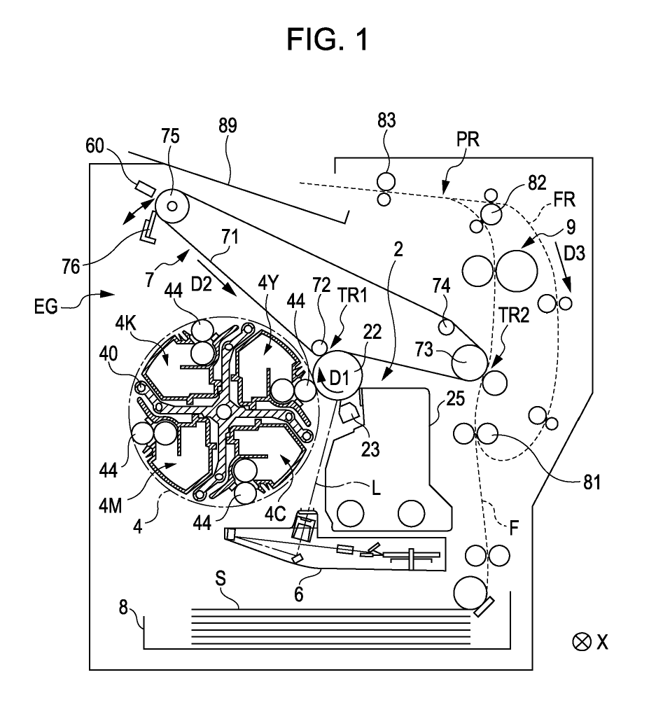

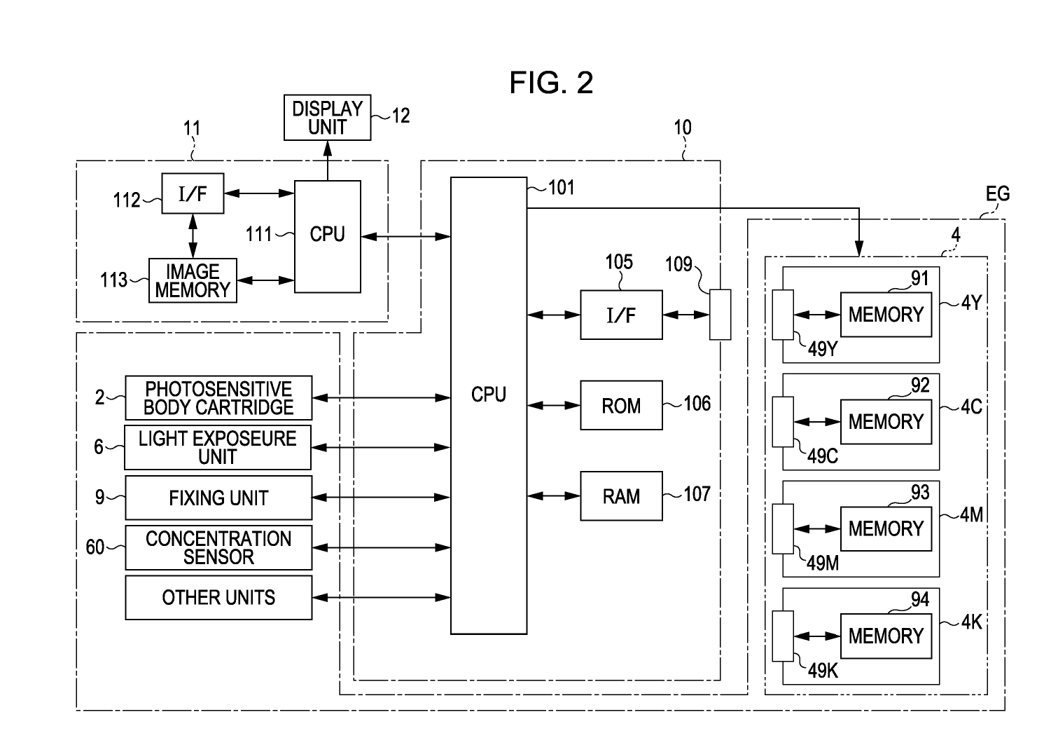

FIG. 1 shows one embodiment of an image forming device to which the invention is applied. Further, FIG. 2 is a block diagram illustrating the electric structure of the image forming device in FIG. 1. This device is the image forming device in which toners (developing agents) of four colors of yellow (Y), cyan (C), magenta (M) and black (K) are overlapped to form a full color image, or, a monochrome color image is formed using only the toner of black (K). In this image forming device, when an image signal from an external device such as a host computer is supplied to a main controller 11, a CPU 101 mounted on an engine controller 10 controls each portion of an engine portion EG according to commands from the main controller 11 to perform a predetermined image forming operation and forms the image corresponding to the image signal on a sheet S.

In the engine portion EG, a photosensitive body 22 is placed so as to be rotatable in arrow direction D1 in FIG. 1. Further, an electrification unit 23, a rotary development unit 4, and a cleaning portion 25 are each arranged along the rotation direction D1 around the photosensitive body 22. An electrification unit 23 is applied with a predetermined electric charge bias and electrifies the outer circumference of the photosensitive body 22 uniformly at a predetermined surface electric potential. The cleaning portion 25 removes the toner remained on the surface of the photosensitive body 22 after a first transfer and is withdrawn into a waste toner tank installed therein. The photosensitive body 22, the electrification unit 23 and the cleaning portion 25 integrally constitute a photosensitive body cartridge 2 and the photosensitive body cartridge 2 as a whole is wholly easily removable from the device main body.

In addition, the outer circumference of the photosensitive body 22, which is electrified by the electrification unit 23, is irradiated with a light beam L from a light exposure unit 6. This light exposure unit 6 exposes the light beam L onto the photosensitive body 22 according to the image signal supplied from the external device to form the electrostatic latent image corresponding to the image signal.

The thus formed electrostatic latent image is toner-developed by the development unit 4. Namely, in this embodiment, the development unit 4 is constituted by a support frame 40 that is mounted rotatably around the rotation axis perpendicular to a paper plane in FIG. 1 and a cartridge that is easily removable from the support frame 40, and it includes a yellow developer 4Y, a cyan developer 4C, a magenta developer 4M and a black developer 4K containing the toners of each color. This development unit 4 is controlled by the engine controller 10. In addition, based on the control command from the engine controller 10, when the development unit 4 is driven for rotation and at the same time these developers 4Y, 4C, 4M and 4K are selectively positioned on the predetermined development position opposite to the photosensitive body 22, development rollers 44 that are installed in the developers and carry the toners of the selected colors are placed opposite to the photosensitive body 22 by a predetermined gap and supply toners from the development rollers 44 to the surface of the photosensitive body 22 in the opposite position. The electrostatic latent image on the photosensitive body 22 is hereby developed into the selected toner colors.

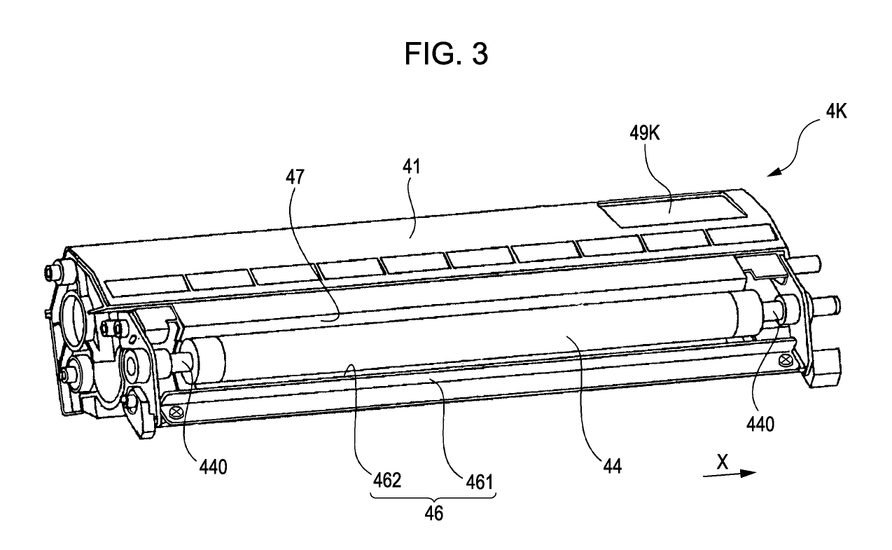

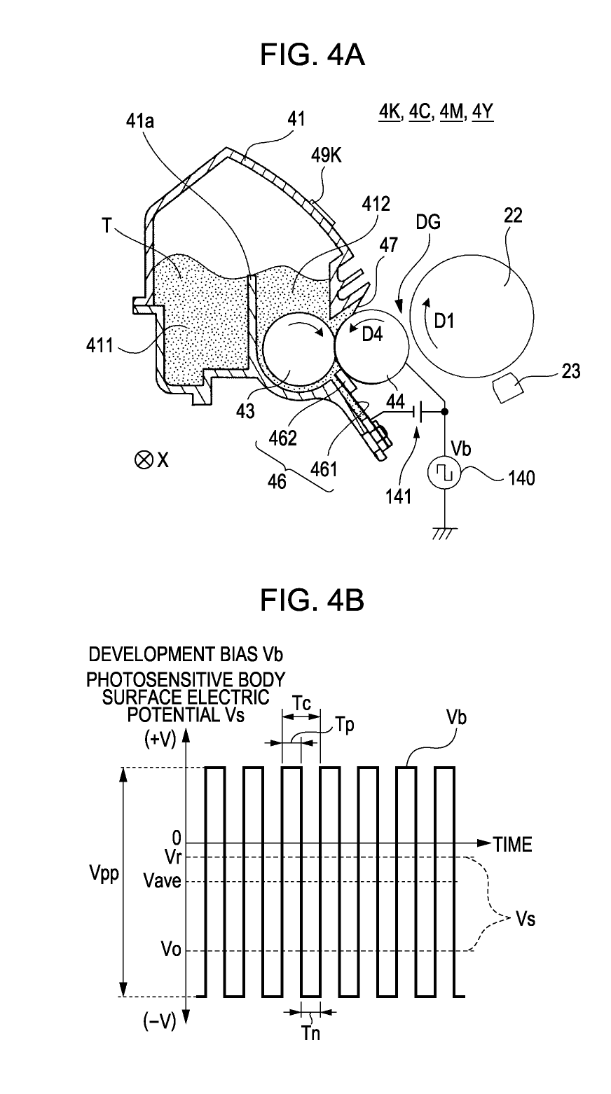

FIG. 3 is a diagram showing the appearance of the developer. Further, FIGS. 4A and 4B are diagrams showing the structure of the developer and the development bias waveform. More specifically, FIG. 4A is a sectional view showing the structure of the developer. Further, FIG. 4B is a diagram showing the relationship of the development bias waveform and the photosensitive body surface electric potential. Each of the developers 4Y, 4C, 4M and 4K has an identical structure. Thus, while the construction of the developer 4K is described herein in more detail with reference to FIGS. 3 and 4A, other developers 4Y, 4C, and 4M also have structures and the functions identical thereto.

In this developer 4K, a supply roller 43 and the development rollers 44 are rotatably pivoted to a housing 41 with a nonmagnetic single component toner T housed therein, and when the developer 4K is positioned in the development position, the development rollers 44 separate the photosensitive body 22 and a development gap DG to be oppositely positioned while these rollers 43 and 44 are connected to a rotation driver (not shown) mounted to the main body side to rotate in a predetermined direction. The supply roller 43 is formed in a cylindrical shape by elastic materials such as urethane foam rubber, silicon rubber and the like, for example. Further, the development rollers 44 are formed in the cylindrical shape by a metal or an alloy such as copper, aluminum, stainless steel and the like. In this embodiment, a device is used in which a steel cylindrical surface is subjected to an electroless nickel-phosphorous plating treatment. Further, two rollers 43 and 44 rotate while contacting each other, so that the toner is friction-attached to the surface of the development rollers 44 to form a toner layer of a predetermined thickness on the surface of the development rollers 44. While a negative electrification toner is used in this embodiment, a positive electrification toner may be used.

The inner space of the housing 41 is partitioned into a first chamber 411 and a second chamber 412 by a partition wall 41a. The supply roller 43 and the development rollers 44 are placed together in the second chamber 412, and the toner in the second chamber 412 is supplied to the surface of the development rollers 44 while being flowed and stirred according to the rotation of the rollers. On the other hand, since the toner contained in the first chamber 411 is separated from the supply roller 43 and the development rollers 44, the toner does not flow according to the rotation thereof. The development unit 4 rotates while supporting the developer, so that this toner is mixed with the toner contained in the second chamber 412 and is stirred.

As described above, according to this developer, the inner portion of the housing is partitioned into two chambers and the supply roller 43 and the development roller 44 are surrounded by the side wall of the housing 41 and the partition wall 41a to provide the second chamber 412 having relatively small capacity, so that even when the remaining amount of the toner is decreased, the toner may be effectively provided to the vicinity of the development roller 44. Further, the toner supply from the first chamber 411 to the second chamber 412 and the stir of the overall toner are performed by the rotation of the development unit 4, thereby obtaining an auger-less structure in which a stirring unit (auger) for stirring the toner with the developer is omitted.

Further, in this developer 4K, there is placed the restriction blade 46 for restricting the thickness of the toner layer to be formed on the surface of the development roller 44 to a predetermined thickness. The restriction blade 46 includes a plate-like member 461 having the elasticity such as a stainless and a phosphor bronze and an elastic member 462 that is positioned on the front end of the plate-like member 461 and is formed of a resin member such as a silicon rubber and a urethane rubber. Conductive particles such as carbon particles are dispersed in the elastic member 462 and the resistivity rate thereof is regulated to about 10⁶ Ωcm. Further, the hardness thereof is JIS-A hardness 70 degrees.

The rear end of the plate-like member 461 is adhered to the housing 41, and in the rotation direction D4 of the development roller 44 indicated by an arrow in FIG. 4A, the elastic member 462 installed at the front end of the plate-like member 461 is placed so as to be positioned further upstream than the rear end of the plate-like member 461. Namely, the restriction blade 46 is installed so that one end thereof (rear end) is fixed while the front end, which is the free end opposite thereto, is directed to the upstream side in the rotation direction D4 of the development roller 44. Thus, the elastic member 462 elastically contacts the surface of the development roller 44 in the so-called counter direction to form a restriction nip and finally restricts the toner layer formed on the surface of the development roller 44 to the predetermined thickness. The contact pressure of the restriction blade 46 to the surface of the development roller 44, namely restriction of load, is regulated to 5 gf/cm.

In this way, the toner layer formed on the surface of the development roller 44 is successively transported to the position opposite to the photosensitive body 22 in which the electrostatic latent image is formed on its surface, by the rotation of the development roller 44. Also, the development bias from the bias power source 140 controlled in the engine controller 10 is applied to the development roller 44. As shown in FIG. 4B, after the surface potential Vs of the photosensitive body 22 is uniformly electrified by the electrification unit 23, the surface potential Vs is decreased to about a remaining potential Vr in the exposure portion illuminated with the light beam L from the light exposure unit 6, and becomes the almost uniform potential Vo in the non-exposure portion that is not illuminated with the light beam L. On the other hand, the development bias Vb provided to the development roller 44 is the rectangular wave alternating voltage in which the direct current is overlapped, and the inter-peak voltage thereof is indicated by symbol Vpp. By applying the development bias Vb, the toner carried on the development roller 44 scatters in the development gap DG, is partly attached to each portion of the surface of the photosensitive body 22 according to the surface potential Vs, and in this manner, the electrostatic latent image on the photosensitive body 22 is developed as the toner image of the toner color.

As the development bias voltage Vb, for example, the rectangular wave voltage, which has the inter-peak voltage Vpp of 1500 V and the frequency of 3 to 4 kHz, can be used. In the repeat cycle Tc of the alternating components of the development bias Vb, if the period in which the potential oscillates in the positive side is indicted by the symbol Tp, the period in which the potential oscillates in the negative side is indicated by the symbol Tn, and at the same time, the waveform duty WD of the development bias Vb is defined by the following formula: WD=Tp/(Tp+Tn)=Tp/Tc, the bias waveform is set so that it becomes Tp>Tn in this embodiment, namely the waveform duty WD is increased more than 50%. Typically, WD=60% may be used.

Since the potential difference between the remaining potential Vr of the photosensitive body 22 and the additional average voltage Vave of the development bias Vb in which the direct current component caused by the waveform duty is added to the direct current component overlapped on the rectangular wave alternating voltage becomes the so-called development contrast and affects the image concentration, the additional average voltage value can be the value that is necessary for obtaining the predetermined image concentration. Typically, it may be (−200) V, for example.

Further, while it will be described in detail later, in this embodiment, the restriction bias power source 141 is connected between the metallic plate-like member 461 constituting the restriction blade 46 and the development roller 44, and the predetermined restriction bias voltage is applied to the elastic member 462 having the conductivity.

In the housing 41, there is installed a seal member 47 that pressure contacts the surface of the development roller 44 in the further downstream side than the position opposite to the photosensitive body 22 in the rotation direction of the development roller 44. The seal member 47 is formed by the resin material having the flexibility such as polyethylene, nylon or fluorine resin, is a band-shaped film that extends along the direction X parallel to the rotation axis of the development roller 44, and the one end in the transverse direction (direction along the rotation direction of the development roller 44) perpendicular to the longitudinal direction X is adhered to the housing 41, while the other end contacts the surface of the development roller 44. The other end contacts the development roller 44 in the so-called trail direction so as to direct the downstream in the rotation direction D4 of the development roller 44, leads the toner remaining on the surface of the development roller 44 that has passed through the position opposite to the photosensitive body 22 into the housing 41, and at the same time prevents the toner in the housing from leaking outside.

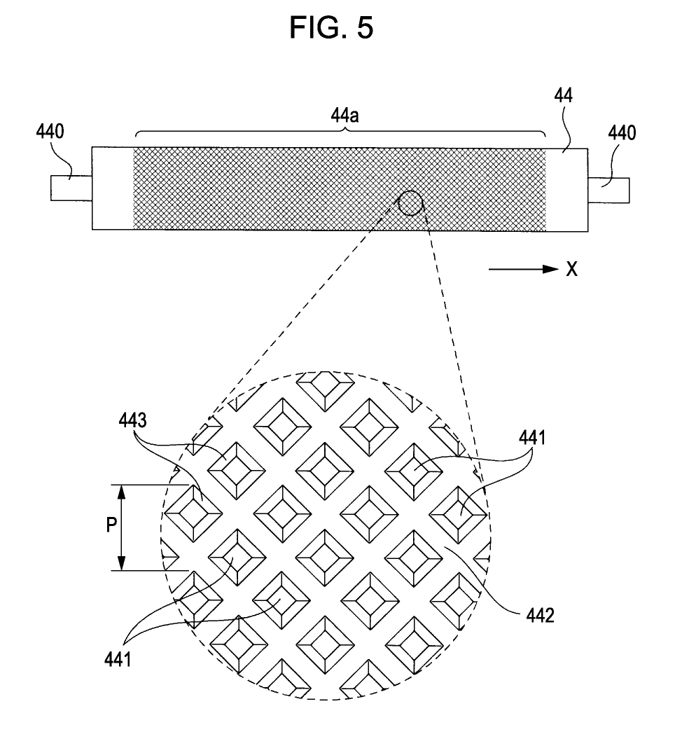

FIG. 5 is a partly enlarged view of the development roller and its surface. The development roller 44 is formed in the shape of nearly cylindrical roller shape, a shaft 440 that is coaxial to the roller is installed at both ends of the longitudinal direction, and the shaft 440 is axis-supported by the developer main body so that the overall development roller 44 is able to rotate. As shown in partly enlarged view (in dotted-line circle) of FIG. 5, a plurality of convex portions 441 regularly positioned and concave portions 442 surrounding the convex portions 441 are installed at a central portion 44a of the surface of the development roller 44.

Each of the plurality of the convex portions 441 protrudes toward the front side of the paper in FIG. 5, and the upper face of each convex portion 441 forms a portion of a single cylindrical face that is coaxial to the rotation axis of the development roller 44. Further, the concave portions 442 are continuous grooves that surround the convex portions 441 in network form, and overall the concave portions 442 also form a single cylindrical face which is coaxial to the rotation axis of the development roller 44 and is different from the cylindrical face formed by the convex portions. Further, the intermediate between the convex portions 441 and the concave portion 442 surrounding it is connected by a gentle side face 443. Namely, a normal of the side face 443 has a component of the radial outward direction (upward direction in the drawing) of the development roller 44, namely the direction facing away from the rotation axis of the development roller 44.

In this embodiment, the arrangement pitch P of the convex portions 441 on the surface of the development roller 44 is 80 μm in the circumferential direction, namely the axis direction (X direction). The depth of the concave portion 442, the difference of elevation between the convex portions 441 and the concave portion 442 is 10 μm. Further, the gap (development gap) between the photosensitive body 22 and the development roller 44 at the development position is 190 μm.

With regard to the development roller 44 having this structure, it may be manufactured by a manufacturing method using the so-called rolling processing described in JP-A-2007-140080, for example. The regular or uniform unevenness can hereby be formed on the cylindrical face of the development roller 44. As a result, the obtained development roller 44 can carry the uniform or optimum amount of the toner on the cylindrical face and can make the rolling mobility (rolling availability) of toner on the cylindrical face of the development roller 44 uniform. As a result, local electrification defect and transport defect of the toner can be inhibited to exhibit an excellent development characteristic. Further, since the unevenness is formed by use of the mold, it is different from the general development roller that has been obtained by the blast processing, and in the obtained unevenness, the width of the front end of the convex portion may be relatively increased. This unevenness has an excellent mechanical strength. In particular, since the region pressurized by the mold is improved in mechanical strength, the obtained unevenness has excellent mechanical strength as compared to that obtained in the treatment such as cutting processing. The development roller 44 having this unevenness can exhibit an excellent durability. Further, when the width of the front end of the convex portion of the unevenness is relatively large, even if it wears, there is little change in the shape, therefore the sudden decrease in the development characteristic can be inhibited, thereby exhibiting the excellent development character for a long time.

Returning to FIG. 1, description of the image forming device will be continued. In this manner, the toner image developed by the development unit 4 is first transferred onto a middle transfer belt 71 of the transfer unit 7 in the first transfer area TR1. The transfer unit 7 includes the middle transfer belt 71 extended among a plurality of rollers 72 to 75 and a driver (not shown) for rotating the middle transfer belt 71 in the predetermined rotation direction D2 by rotatably driving the roller 73. Further, when the color image is transferred onto the sheet S, the toner image of each color formed on the photosensitive body 22 is overlapped over the middle transfer belt 71 to form the color image, and at the same time the color image is second transferred onto the sheets S that are taken one by one from a cassette 8 and transported up to second transfer area TR2 along the transport path F.

At that time, in order to accurately transfer the image on the middle transfer belt 71 in the predetermined position on the sheet S, the timing when the sheet S is transported to the second transfer area TR2 is managed. Concretely, a gate roller 81 is installed in the front side of the second transfer area TR2 on the transport path F, and by rotating the gate roller 81 in accordance with the timing of the circumferential rotation movement of the middle transfer belt 71, the sheet S is transported to the second transfer area TR2 at the predetermined timing.

Further, in this manner, the sheet S with the color image formed thereon is fixed on the toner by a fixing unit 9 and is transported to a discharge tray unit 89 installed on the upper face portion of the device main body through a before discharging roller 82 and a discharging roller 83. Further, when the image is formed on both surfaces of the sheet S, at the point of time when the rear end of the sheet S with the image formed on one surface is transported to the reverse position PR behind the before discharging roller 82, the rotation direction of the discharging roller 83 is reversed, whereby the sheet S is transported in the arrow direction D3 along the reverse transport path FR. Further, the sheet rides on the transport path F again in front of the gate roller 81, at this time, however, the surface of the sheet S that comes in contact with the middle transfer belt 71 in the second transfer area TR2 to be transferred with the image is opposed to the surface in which the image has been transferred in advance. In this way, it is possible to form the image on both surfaces of the sheet S.

Further, as shown in FIG. 2, in each of the developers 4Y, 4C, 4M and 4K, there are each installed memories 91 to 94 that store the data about the manufacturing lot and the use history of the developers and the remaining amount of the built-in toner and the like. Further, wireless-communicators 49Y, 49C, 49M and 49K are installed in each of the developers 4Y, 4C, 4M and 4K, respectively. Further, as necessary, those developers selectively perform the non-contact data communication with the wireless communicator 109 installed at the main body side, and they send and receive the data between a CPU 101 and each memory 91 to 94 through the interface 105 to perform the management of various kinds of information such as consumable supply management on the developers. Further, while in this embodiment, the data is sent and received in the non-contact manner by use of the electromagnetic unit such as the wireless communication, a connector and the like may be installed at the main body side and in each developer side, and the connector and the like may be mechanically fitted together to mutually send and receive the data.

Further, in this device, as shown in FIG. 2, there is provided a display portion 12 that is controlled by the CPU 111 of the main controller 11. This display portion 12 is, for example, constituted by a liquid crystal display and displays predetermined messages for informing the user of an operation guide and the progressive situation of the image forming motion, the abnormality occurrence of the device, the changing time of any one of unit and the like, according to the control command from the CPU 111.

Further, in FIG. 2, reference numeral 113 indicates an image memory that is installed in the main controller 11 so as to store the image provided though an interface 112 from the external device such as a host computer. In addition, reference numeral 106 indicates a ROM to store an operation program executed by the CPU 101 and a control data for controlling the engine portion EG and the like. Further, reference numeral 107 indicates a RAM that temporarily stores the operation results in the CPU 101 and the other data.

Further, a cleaner 76 is positioned near the roller 75. This cleaner 76 is capable of moving to and from the roller 75 by an electromagnetic clutch (not shown). In addition, in a state of moving to roller 75, the blade of the cleaner 76 contacts the surface of the middle transfer belt 71 spanning the roller 75 and it removes the toner remaining attached to the outer circumference surface of the middle transfer belt 71 after the second transfer.

Further, a concentration sensor 60 is positioned near the roller 75. This concentration sensor 60 is installed opposite to the surface of the middle transfer belt 71, and as necessary, measures the image concentration of the toner image formed on the outer circumference surface of the middle transfer belt 71. Further, based on the measurement results, in this device, the regulation of the motion condition of each portion of the device influencing the image quality is performed, for example the development bias provided to each developer, the intensity of the light exposure beam L, and a gradation correction property and the like.

This concentration sensor 60 is configured to output the signal corresponding to the shading of the zone of the predetermined area on the middle transfer belt 71, by use of a reflection type photo sensor. In addition, by regularly sampling the output signal from the concentration sensor 60 while circularly moving the middle transfer belt 71, the CPU 101 is capable of detecting the image concentration of each portion of the toner image on the middle transfer belt 71.

Next, the toner used in this embodiment will be described. The toner is the non-magnetic single-component toner manufactured by the ordinary grinding method and has a property of being electrified to the negative polarity by means of the frictional electrification. This toner has a volume average particle diameter (hereinafter, indicated by reference term Dave) of 8 μm and, as the external additives, two types of silica having the volume average particle diameters of 12 nm and 50 nm are included in the ratio of 1.0% by weight and 0.5% by weight, respectively. Further, as the metal oxide external additive for regulating the electrification amount, the titanium oxide (titania) having volume average particle diameter of 30 nm is included in the ratio of 1.0% by weight. The reason that the toner composition is set as above will be described later. Further, in the following description, unless otherwise specified, the properties of the toner used in the experiments are identical to those described above.

The techniques for improving the electrification property of the toner on the development roller by the application of the bias to the restriction blade have been proposed in the past, in addition to the above-described JP-A-2005-331780, there are JP-A-2006-220967 and JP-A-58-153972 and the like, for example. In the above patent documents, in addition to the application of the bias to the restriction blade, it is described that a suitable regulation of the conductivity of the toner particles is advantageous in improving the electrification amount of the toner. However, according to the various experiment results performed by the inventors, other knowledge was obtained.

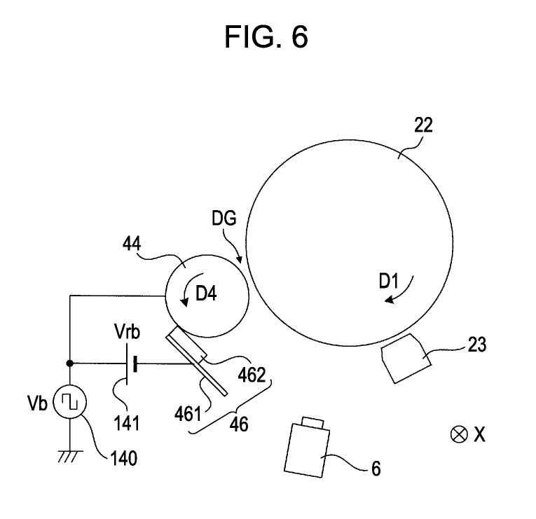

FIG. 6 is a diagram illustrating the outline of the experiments performed by the inventors. In the experiment, the photosensitive body 22 was electrified to the predetermined surface potential by the electrification unit 23 while being rotated in the rotation direction D1, and in a state that the exposure by the light exposure unit 6 was not executed, the development bias Vb was applied to the development roller 44. At that time, the intermediate between the development roller 44 and the restriction blade 46 was electrically connected through the restriction bias power source 141 and the restriction bias voltage Vrb was applied to the restriction blade 46. In this state, the restriction bias voltage Vrb and the composition and properties of the toner were variously changed to estimate the development characteristics.

First of all, with the surface of the development roller 44, when the toner layers exceeding one layer are carried on the convex portion 441 or the toner layers exceeding two layers are carried on the concave portion 442, regardless of other conditions, the toner scattering from the development roller 44 and the fogging occurrence is noticeable. Thus, in the following experiment, by the so-called edge restriction in which the upstream edge of the elastic member 462 of the restriction blade 46 comes in contact with the convex portion 441 of the surface of the development roller 44, the toner carrying to the convex portion 441 is restricted, and at the same time the elevation difference between the convex portion 441 and the concave portion 442 is set to the value that exceeds once and does not exceed twice the volume average particle diameter of the toner, whereby the toner layer in the concave portion 442 is set to about 1 to 1.5 times. For this purpose, in the development roller 44 used in the experiment, the elevation difference between the convex portion 441 and the concave portion 442 is 15 μm (≈1.88 Dave).

When the toner layer of the development roller exceeds one layer, in the toner layer, there are mixed the toner (contact toner) that is carried on the surface of the development roller in the direct contact manner and the toner (noncontact toner) that does not directly contact the development roller surface but is carried over the contact toner on the surface. While it will be described in detail later, due to the difference in the attachment forces to the development roller, the contact toner is hardly separated from the development roller surface and the noncontact toner is easily separated therefrom. In this point, while it is desirable that the toner layer be constituted only by the contact toner from the viewpoint of inhibiting the scattering and the fogging, it is desirable that the toner layer include the noncontact toner that is easy to separate from the viewpoint of obtaining the sufficient development concentration. Ideally, the toner layer that includes both the contact toner and the noncontact toner is carried and the policy to inhibit the scattering and the fogging is adopted.

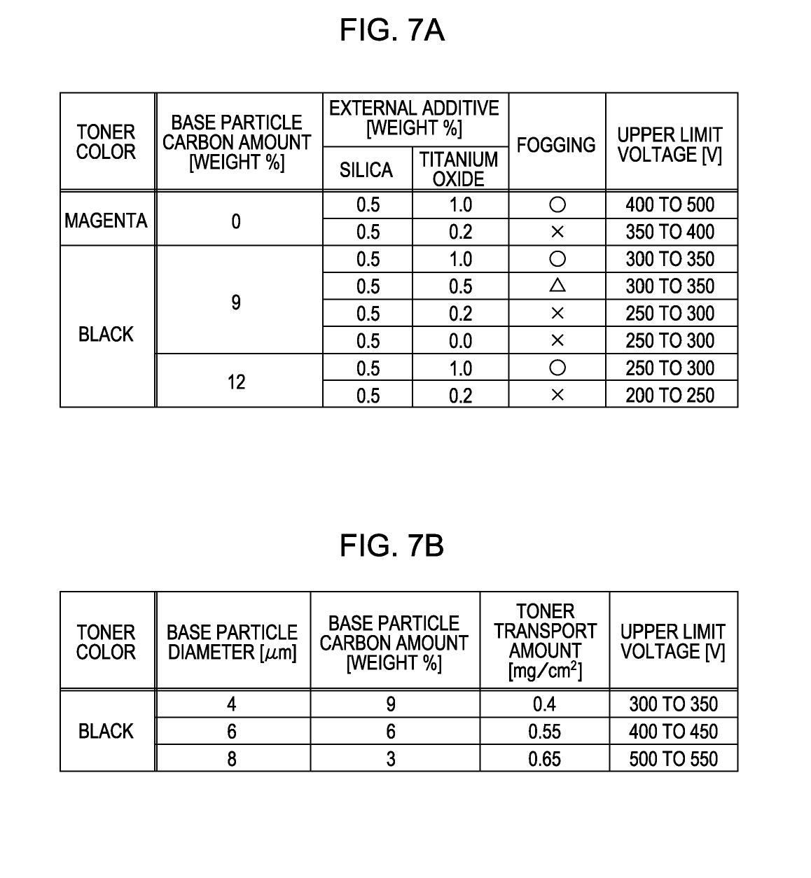

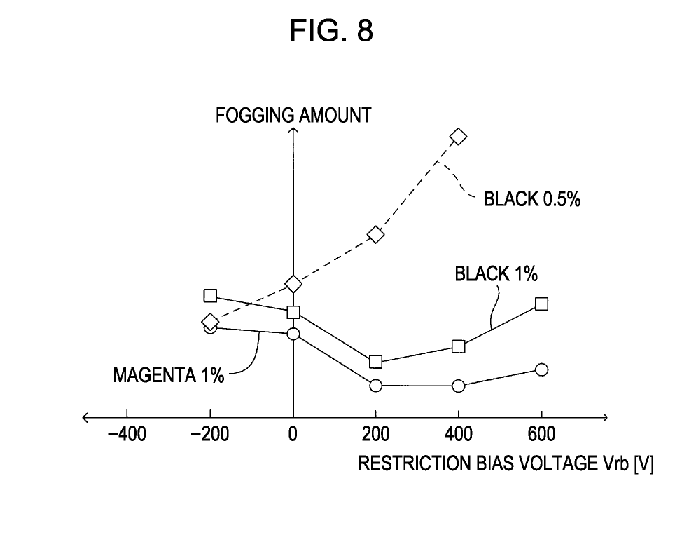

FIGS. 7 and 8 are diagrams illustrating one portion of the experiment results. Individual experiment contents and the results thereof will be described in detail. FIG. 7A is an evaluation result of the fogging amount to the photosensitive body 22 and the development concentration, when 200 to 500 V is applied as the restriction voltage Vrb and the content of the carbon black in the toner base particle and the content of the titanium oxide as the external additive are changed. Herein, the magenta toner having the volume average particle diameter of 8 μm and two types of the black toners having different carbon contents are used. While the carbon black is added to the black toner particles as the black pigment, in order to have the conductivity, the carbon black has also the function of controlling the conductivity of the toner, in that the more the content, the higher the conductivity of the toner base particle. Naturally, the carbon black is not included in the magenta toner. Thus, the three types of the toners are different in the conductivities of the base particles.

When the amount of the silica having a diameter of 50 nm as the external additive is regular (0.5% by weight) and the content of the titanium oxide is changed, the fogging amount is accordingly changed. In the drawing, symbol “◯” indicates that the fogging amount is small, symbol “X” indicates that the fogging amount is large and symbol “Δ” indicates that the fogging amount is medium. According to this result, regardless of the carbon content of the toner base particle, the more the content of the titanium oxide as an external additive, the less the fogging amount. More concretely, when the titanium oxide content is higher than the silica content, the fogging is small. In order to obtain a sufficient fogging suppression effect, at least like the silica content, the titanium oxide of 0.5% by weight is required.

While the description is omitted, even if the silica amount as the external additive is changed, there is mostly no difference in the results of the experiment. However, if the silica amount is larger than the titanium oxide amount and specifically the content of the silica having a large diameter is large, even if the amount of the titanium oxide is added and subtracted, the fogging reduction effect was mostly not obtained.

On the other hand, regarding the development concentration, it was evaluated as follows. As shown in FIG. 6, the polarity of the restriction bias voltage Vrb is defined in the direction in which the restriction blade 46 is made to have a low potential to the development roller 44. Thus, in the value (200 to 500 V) of the restriction bias voltage Vrb in this experiment, the restriction blade 46 rather than the development roller 44 becomes the negative potential. Due to the negative voltage applied to the restriction blade 46, the toner electrification amount is not only increased but also the electric field is formed that is directed to the development roller 44 from the restriction blade 46, and the toner electrified with the negative polarity is pressurized against the development roller 44, with a result that the development property is decreased and the development concentration is decreased. Further, if the application voltage to the restriction blade 46 is too high, as soon as the current flows in the toner particles and the toner surface, the electrification charge is scattered to cause the poor transportation and generate the concentration non-uniformity of the image. Thus, the value of the restriction bias voltage Vrb in which the poor transportation begins to appear is described as “an upper limit voltage”. If the amount of the titanium oxide as the external additive is small, the upper limit voltage is decreased, and this means that the range in which the restriction bias voltage Vrb can be obtained is narrowed and the degree of freedom of the design declines.

FIG. 7B is the result that compares the toner transportation amount on the surface of the development roller 44 and the above upper limit voltage to the black toners having different particle diameters. Also herein, since the toner layer in the concave portion 442 is regulated to 1 to 1.5 layers, it is thought that the difference between the toners is mainly due to the carbon black contents of the base particles. Although it corresponds to the result illustrated in FIG. 7A, the upper limit voltage is decreased in the toner having the high carbon content. Further, in the condition of low upper limit voltage, a stable improvement of the electrification amount of the toner of the development roller 44 surface was not noticeable. It is thought that this is because if the conductivity of the toner base particle becomes high, the leak current flows through the toner between the development roller 44 and the restriction blade 46, whereby the electrification amount of the toner is disordered.

As described above, in the structure in which the bias voltage is applied to the restriction blade 46 to intend to control the electrification amount of the toner of the development roller surface, an increase in the conductivity of the toner does not lead to excellent results, but rather an opposite effect may be caused. Namely, the model in which “the electrification amount is improved by providing the conductive toner with the electric charge” was incapable of being proved in this experiment.

FIG. 8 is a diagram illustrating the measurement result of the fogging amount when the restriction bias voltage is changed. As the toner, the magenta toner including titanium oxide of 1% by weight and two types of black toners in which the amounts of the titanium oxide were 1% by weight and 0.5% by weight were used. As a result, in the toner having the amount of titanium oxide of 1% by weight, when a suitable positive voltage (the negative voltage that is identical to the electrification polarity of the toner, when seen from the restriction blade 46) as the restriction bias voltage Vrb is applied to the magenta and black, the fogging amount becomes the minimum. In this regard, in the toner having low titanium oxide content, if the negative voltage is applied to the restriction blade 46, the fogging amount is increased, and rather when the voltage having the polarity opposite to the electrification polarity of the toner is applied to the restriction blade 46, the fogging amount is decreased. Further, when the contents of the titanium oxide are identical, the magenta toner, which has smaller carbon content and lower conductivity than the black toner, has a small fogging amount.

As described above, in order to improve the electrification amount of the toner to reduce the scattering and the fogging, it is desirable that the content of the titanium oxide as the external additive rather than the conductivity of the toner be controlled. More concretely, it is desirable that a suitable amount of the titanium oxide as the external additive is added to the toner and at the same time a suitable restriction bias voltage having the same polarity as the electrification polarity of the toner is applied to the restriction blade 46.

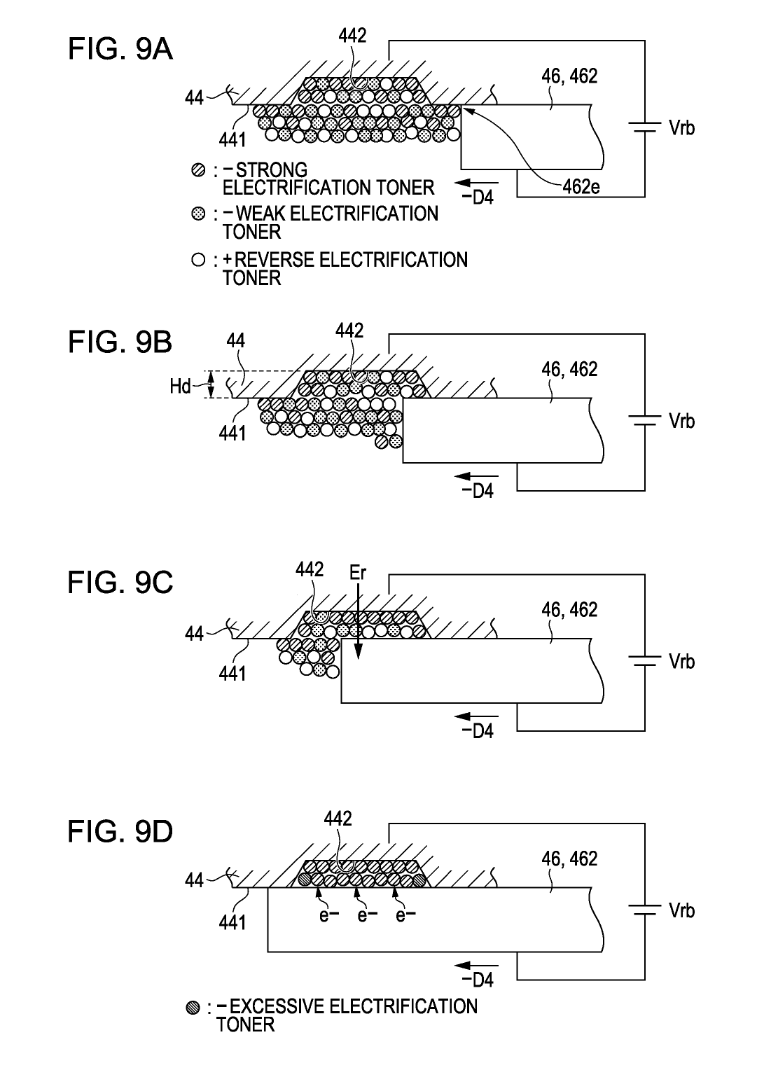

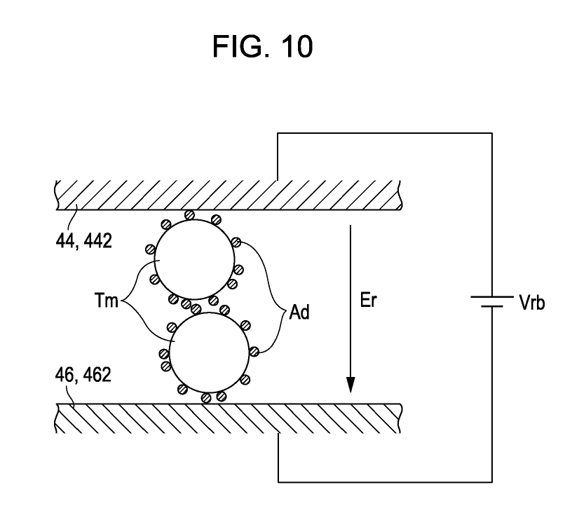

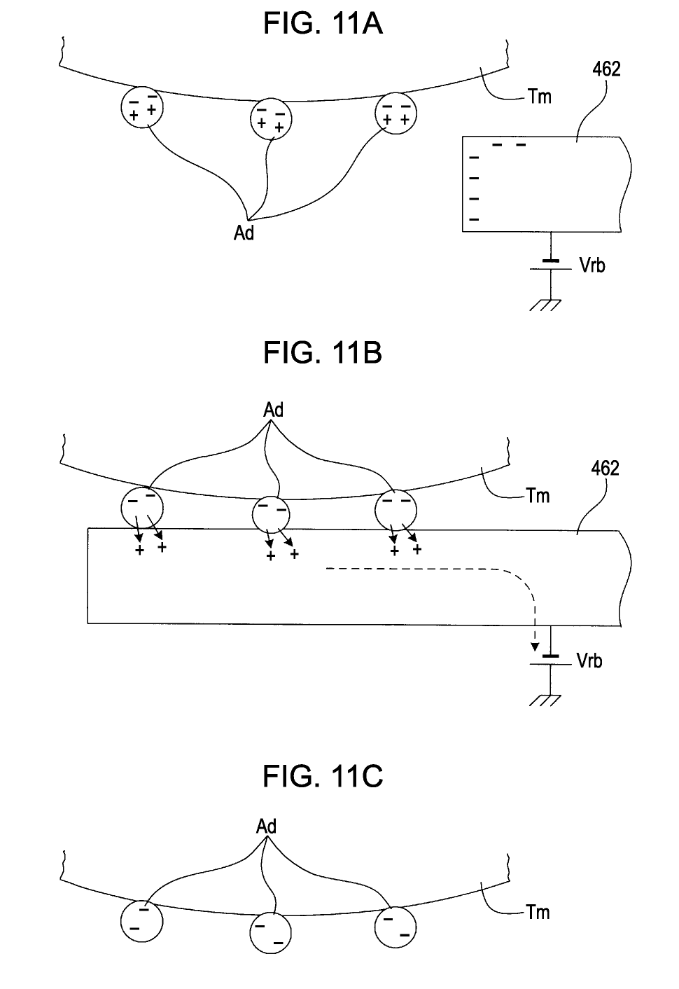

FIGS. 9 to 11 are diagrams illustrating the models of the mechanism in which the electrification amount of the toner in this embodiment is improved. More concretely, FIG. 9 is a model diagram showing the behavior of the toner in the concave portion. Further, FIG. 10 is a model diagram showing the development of FIG. 9 more microscopically, and FIG. 11 is a model diagram showing the development of FIG. 10 even more microscopically. Herein, this model is referred to as “rearrangement-induction electrification model”.

Variation in the electrification is present in the toners and there are included toner that has a high or low electrification amount and toner that is electrified to the positive polarity opposite to the original electrification polarity (negative n polarity). Hereinafter, for convenience, of the toner electrified to the negative polarity that is the original electrification polarity, the toner that has relatively high electrification amount is referred to as “a strong electrification toner”, the toner that has low electrification amount is referred to as “a weak electrification toner”, and the toner that is electrified to the opposite polarity (namely, positive polarity) is referred to as “a reverse electrification toner”. Further, in particular, the toner that has high electrification amount among the strongly electrified toner is referred to as “an excessive electrification toner.”

As described in FIG. 9A, before the layer is restricted by the restriction blade 46, the toner particles having different electrification amounts are distributed on the surface of the development roller 44. Of this, the strong electrification toner having relatively high electrification amount can be strongly attracted onto the metal surface of the development roller 44 by the action of mirror image force. As a result, many strong electrification toners are present in the position close to the surface of the development roller 44, whereas the weak electrification toner and the reverse electrification toner are pressurized thereto and are present in the position separated from the surface of the development roller 44.

The development roller 44 rotates in the rotation direction D4, whereby the restriction blade 46 (more specifically, the elastic member 462 constituting the restriction blade 46) moves relatively (−D4) in the direction. In this embodiment, since an edge portion 462e of the elastic member 462 present in the uppermost portion in the rotation direction D4 of the development roller 44 is the edge restriction that comes in contact with the convex portion 441, as shown in FIG. 9B, the toner is eliminated from the convex portion 441, along with the progress in the direction (−D4) of the restriction blade 46. Further, in the concave portion 442, the toner having the thickness greater than that corresponding to the elevation difference Hd between the convex portion 441 and concave portion 442 is printed and cut and also eliminated. In this embodiment, since, regarding the volume average particle diameter of the toner of 8 μm, the elevation difference Hd between the convex portion 441 and the concave portion 442 is 10 μm, the toner layer of the concave portion 442 has the thickness that is greater than one layer but is smaller that two layers.

At this time, if the restriction bias voltage Vrb is applied between the development roller 44 and the restriction blade 46, as shown in FIG. 9C, the electric field (hereinafter, referred to as “the restriction electric field”) Er of the direction facing from the development roller 44 to the restriction blade 46 is formed on the concave portion 442. This restriction electric field Er generates the force that pushes toward the surface side of the development roller 44, to the toner electrified negatively. Since this force acts strongly by means of the toner having the high electrification amount, strong force that pushes the toner toward the development roller 44 surface acts on the strong electrification toner. In this regard, regarding the low electrification toner and the reverse electrification toner having lower electrification amount, this force is weaker or the force acts in reverse direction, as a consequence, the strong electrification toner is collected in the position close to the development roller 44 surface, whereas the weak electrification toner and reverse electrification toner move in the direction separated away from the development roller 44 surface. In this way, toners are rearranged in the concave portion 442 and are carried on the position close to the development roller 44 as much as the toner having the high electrification amount, whereas the toner having the low electrification amount or the toner electrified to reverse polarity is carried at the position separated from the development roller 44 surface.

In this embodiment, since the toner layer of the concave portion 442 is less than two layers, as shown in FIG. 9C, the low electrification toner or the reverse electrification toner that are carried at the position separated from the development roller 44 contact the restriction blade 46. At this time, as shown in FIG. 9D, the negative electric charge (indicated by reference numeral “e-”) is injected to the toner from the restriction blade 46 that is applied with the restriction bias voltage Vrb (negative voltage to the development roller 44) so that the electrification amounts of the low electrification toner and the reverse electrification toner having the insufficient electrification amount are increased. Further, it is thought that a portion of the toners carried so as to contact the development roller 44 also contacts the restriction blade 46, but this toner also may increase in the electrification amount and become the excessive electrification toner. The excessive electrification toner is hard to separate from the surface of the development roller 44 due to the high electrification amount, and if the excessive electrification toners become too increased, the development property is decreased and it becomes a cause of the concentration decline, but it does not become a particular problem in terms of the scattering and fogging suppression.

An electric charge injection mechanism by contact with the restriction blade 46 will be described in detail with reference to FIGS. 10 and 11. As shown in FIG. 10, the toner particles are in the state in which the fine external additives Ad are scattered around the base particle Tm. Further, these toner particles are charged between the concave portion 442 of the development roller 44 and the elastic member 462 of the restriction blade 46, and herein the restriction electric field Er is formed by the restriction bias voltage Vrb. Basically, the toner that contacts the surface of the development roller 44 (the concave portion 442) does not contact the restriction blade 46 (the elastic member 462), on the contrary, the toner that contacts the restriction blade 46 does not contact the development roller 44.

Herein, when the toner base particle Tm and the external additives Ad have the sufficient conductivities, the leak currents flow therethrough. It is thought that this current merely passes through the inside of the particles of the toner and does not contribute to the electrification of the toner. However, there is a possibility that the electrification charge of the toner deviates outside and the electrification amount is scattered. In the meantime, if the conductivities of the toner base particles Tm are low, this leak current mostly does not flow, unless the external additives Ad are conductive and densely cover the overall surface of the base particles Tm. Herein, toner base particles that do not have the conductivity are considered.

It is known that the titanium oxide and other metal oxides used as the external additives Ad are different from the silica having high insulation property similarly used as the external additives and exhibit the slight conductivity (about 10⁷ to 10⁸ Ωcm) in the minute particle state. The toner in this embodiment is such that the external additives having this property are added in a suitable amount and the surface of the base particles Tm is sparsely covered with the external additives Ad.

Regarding the toner that does not contact the development roller 44, there occurs a phenomenon in which the restriction blade 46 gradually approaches and contacts the development roller and separates therefrom, according to the rotation of the development roller 44. Among them, in the approach procedure, as shown in FIG. 11A, the elastic member 462 provided with the negative bias Vrb approaches, whereby the positive electric charge is attracted into the side of the elastic member 462 by electrostatic induction in the external additives Ad on the surface of the toner base particles Tm. In this state, when the external additives Ad contact the elastic member 462, as shown in FIG. 11B, the positive electric charge moves to the elastic member 462. This is identical to where the negative electric charge is injected into the external additives Ad from the elastic member 462. In addition, finally, when the elastic member 462 separates, as shown in FIG. 11C, the external additives Ad enters a state where the negative electric charge is excessive. As a result, it is thought that the electric charge of the external additives Ad is applied to the electrification charge that the toner base particles Tm had originally, by the frictional electrification, whereby the electrification amount as the overall toner particles is increased.

According to this rearrangement and induction electrification model, the prior experiment results can be readily described. Namely, regardless of whether or not the toner base particles Tm are conductive, if a suitable amount of titanium oxide is added as the external additives Ad and the bias having the same polarity as the electrification polarity of the toner is applied to the restriction blade 46, the electrification amount of the toner is improved and the fogging is suppressed. It is thought that this is because the titanium oxide external additives receive the negative electric charge from the restriction blade 46 and the electrification amount as the whole toner particles is increased. Further, while there is a result that the toner that has low carbon content, namely that has low conductivity, has high upper limit voltage for obtaining the development concentration with slight fogging (for example, FIG. 8), it is thought that this is because if the conductivity of the toner base particles becomes high, the electric charges injected to the external additives leak to the base particles and therefore the external additives cannot hold the electric charges (namely, cannot hold the electric charges as the overall toner particles).

Further, regarding the influences of the silica as the insulative external additives, it can be thought of as follows. These insulative external additives are to impede the supply of the electric charges from the restriction blade 46 to the titanium oxide external additives. Especially, the influences are great when its diameter is large and the addition amount is large. In the experiment results, it is thought that when the amount of the titanium oxide is larger than that of the silica external additives having a large diameter, the improvement in the electrification property is noticeable, and then by making the titanium oxide larger than the insulative external additives, the electric charges from the restriction blade 46 can be reliably received, thereby leading to the improvement in the electrification property.

When the toner layer carried on the concave portion 442 is made to be larger than one layer or to be smaller than two layers, in the fogging and the development concentration, the most excellent results were obtained, but it is thought that this is because, according to the toner rearrangement and induction electrification process in the concave portion 442, since the strong electrification toner with a high original electrification amount is not influenced and the electric charge can be selectively injected only to the weak electrification toner and the reverse electrification toner, the change in the electrification amounts is small. The effect of suppressing the electrification amount can be obtained by the construction in which the elevation difference between the convex portion and the concave portion is managed by installing the regular unevenness on the surface of the development roller 44 and the toner is carried only on the concave portion.

In fact, it is evident that if the carried toner layer is too thick, the scattering and the fogging is increased, and it is thought that this is because the amounts of the weak electrification toner and the reverse electrification toner in which the electric charge should be injected become too large, and therefore the toners in which the insufficiency of the electrification amount cannot not be entirely supplemented are increased. Especially, since in the toner layers exceeding two layer, there is a toner that contacts neither the development roller 44 nor the restriction blade 46, even in the rearrangement and induction electrification model, the toner in which the electrification amount cannot be increased appears. On the contrary, if the toner layer is thin, the fogging is satisfactory, but the development concentration is extremely decreased. It is thought that this is merely because not only is the transport amount of the toner small, but also the toner having the original high electrification amount is excessively electrified by the electric charge injection, and the attachment force to the development roller 44 becomes strong, whereby it is difficult to transfer the toner onto the photosensitive body 22.

Further, as described above, instead of inhibiting the toner carrying on the convex portion 441, the toner of less than one layer may be carried. By making the toner layer less than one layer, the toner is carried on the upper face of the convex portion 441 in the direct contact state. Further, the toner contacts the restriction blade 46, thereby resulting in the electrification amount being increased. As a result, the toner is strongly attached to the upper face of the convex portion 441 by the mirror image force and therefore the toner scattering due to the rotation of the development roller 44 hardly occurs. In addition, if the toner of the convex portion flies up in the development gap DG due to the action of the development bias Vb, the improvement in the development concentration can be expected. Further, even if the toner does not fly up, since the development concentration is identical to the case where the toner is not carried on the convex portion, there is no disadvantage even in the viewpoint of the development concentration. Rather, since by selectively attaching the toner of small particle diameter to the convex portion 441, a fluctuation in the toner particle diameters in the concave portion 442 is suppressed, as a result particularly when the toner including a plurality of small particle diameters and the toner in which a fluctuation in the particle size is great are used, this method is efficient.

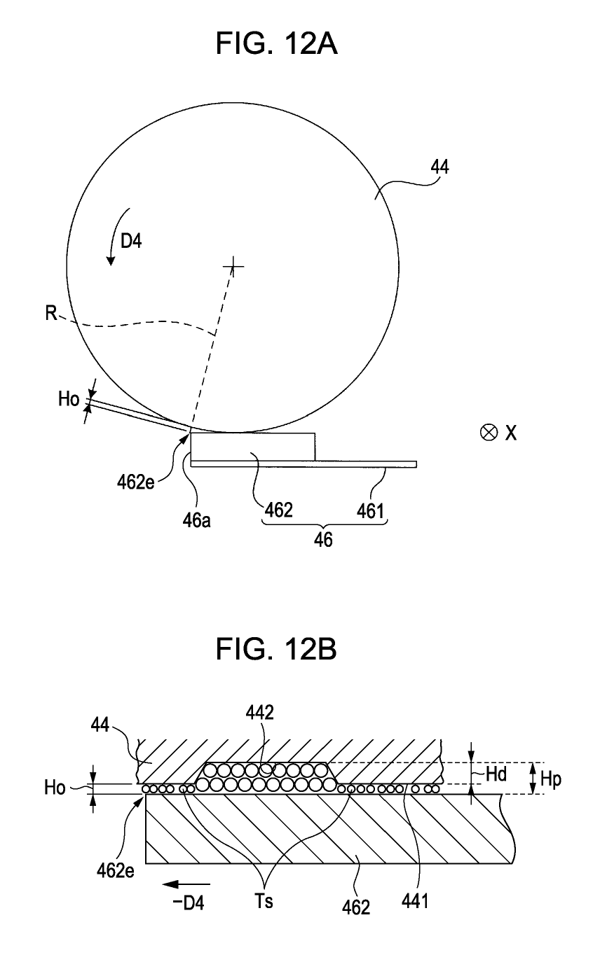

FIG. 12 is a diagram illustrating the modified example in which the toner carrying on the convex par is allowed. When the toner carrying on the convex portion is allowed, as shown in FIG. 12A, the upper side end 46a of the restriction blade 46 is protruded to the upstream side (left side in the drawing) and the predetermined gap Ho (>0) between the edge portion 462e of the elastic member 462 and the surface of the development roller 44 may be provided. As a result, an opening facing the upstream side is formed between the elastic member 462 and the surface of the development roller 44, and the toner having the particle diameter below the opening height Ho corresponding to the gap therebetween is allowed to be carried on the convex portion. Here, regarding the opening height Ho, it is defined as the gap along a straight line R which connects the rotation center of the development roller 44 and the edge portion 462e of the elastic member 462.

If this opening height Ho is smaller than the volume average particle diameter Dave of toner, as shown in FIG. 12B, the toner Ts having the particle diameter smaller than the volume average particle diameter Dave can be only carried on the convex portion 441. Since the strong mirror image force acts on the toner having a small particle diameter owing to the small diameter, such toner is difficult to separate from the development roller 44, and since the electrification amount is increased through contact with the restriction blade 46, it is possible to reliably inhibit the scattering and the fogging by attaching only this toner to the convex portion. Further, since in this embodiment, the frictional electrification of the toner by the restriction blade 46 is not expected, it is not required that the restriction blade 46 be pushed against the development roller 44 with a high load, and the restriction load is about 5 gf/cm. If this load is used, the filming resulting from the pressurization of the toner of the convex portion 441 to the restriction blade 46 is not a problem.

In the mean time, in order to obtain the effect of suppressing the electrification change in the concave portion 442, it is necessary that the toner layer in the concave portion 442 be larger than one layer and less than two layers. This is because the toner layer becomes excessively electrified in less than one layer and, if exceeding two layers, the toner that contacts neither the development roller 44 nor the restriction blade 46 appears. Since the gap Hp between the concave portion 442 and the restriction blade 46 is a sum of the gap between the convex portion 441 and the restriction blade 46, namely the opening height Ho, and the elevation difference Hd between the convex portion 441 and the concave portion 442, it is desirable that this value Hp is a value between one time larger than and twice smaller than the volume average particle diameter Dave of the toner.

Next, the combination of the toner transport amount in the development roller 44 and the restriction bias voltage Vrb applied to the restriction blade 46 was changed and the properties of the toner layer on the development roller were estimated. Concretely, by changing the elevation difference Hd between the convex portion 441 and the concave portion 442 of the surface of the development roller 44, and the gap (opening height) Ho between the convex portion 441 and the uppermost edge portion 462e of the restriction blade 46, two samples having different thicknesses of the toner layer were prepared, and the restriction bias voltage Vrb was changed in each sample.

In a first sample, the opening height Ho was 20 μm and the elevation difference Hd was 6 μm. Hereinafter, this condition is referred to as “restriction condition 1”. At this time, the opening height Ho is greater than the volume average particle diameter Dave of the toner, and the toner of more than two layers is carried on the convex portion and the concave portion. In the meantime, in a second sample, the opening height Ho was 5 μm and the elevation difference Hd was 10 μm. Hereinafter, this condition is referred to as “restriction condition 2”. This restriction condition is adopted in this embodiment. At this time, the opening height Ho is smaller than the volume average particle diameter Dave of the toner, and the gap Hp (=Ho+Hd=15 μm) between the concave portion 442 and the restriction blade 46 is about 1.88 times the volume average particle diameter Dave of the toner.

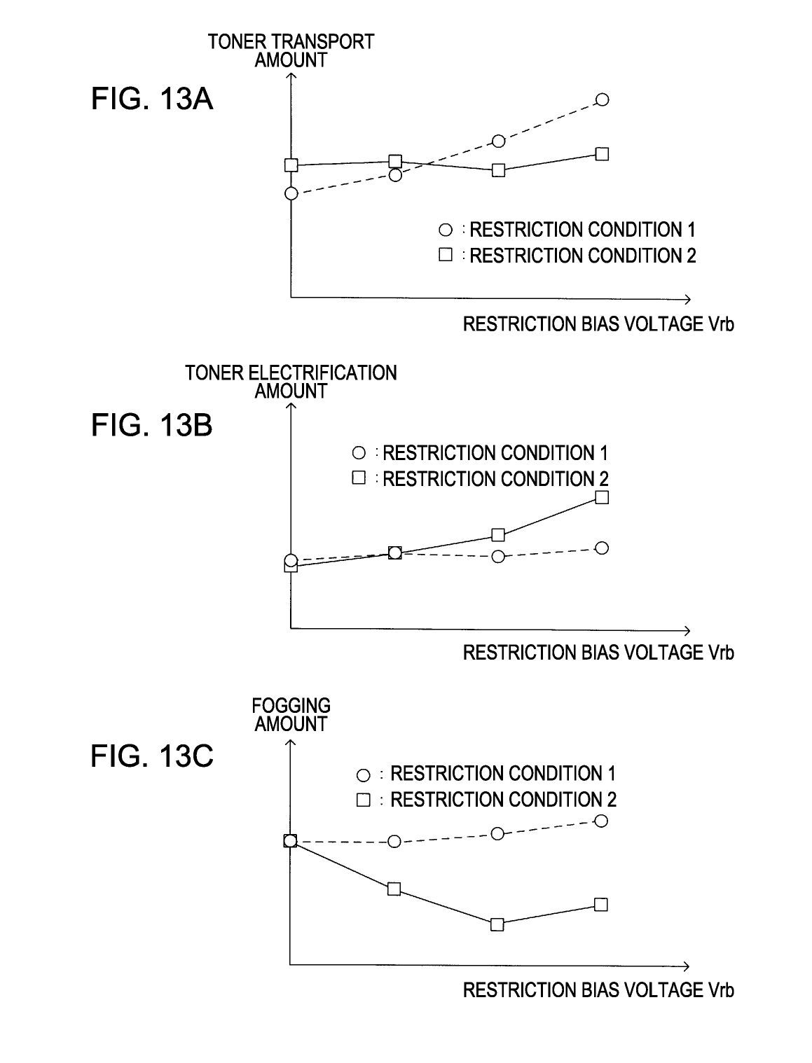

FIGS. 13A-13C are diagrams illustrating the measurement result of the properties of the toner layer in another restriction condition. In the drawing, the restriction bias voltage Vrb of the transverse axis illustrates that the negative electric potential of the restriction blade 46 is increased as much as the right side. First of all, regarding the toner transport amount of the development roller 44, as shown in FIG. 13A, in restriction condition 1, an increase in the transport amount according to the bias value appeared, but in restriction condition 2, the restriction amount was nearly regular. Further, regarding the electrification amount (Q/M) per a mass of the toner, as shown in FIG. 13B, there was little change in restriction condition 1, and in the restriction condition 2, the electrification amount was increased according to the bias value. In addition, regarding the fogging, as shown in FIG. 13C, it was not much changed or slightly increased by the bias value in restriction condition 1, while in restriction condition 2, it was possible to reduce the fogging amount by providing a suitable restriction bias voltage Vrb (typically, about 400 V).

As described above, for the purpose of suppressing the fogging in order to suppress the change in the electrification amount of the toner, it is beneficial that, after the toner amount transported onto the development roller 44 by contacting the restriction blade 46 has been mechanically restricted in advance, the suitable restriction bias voltage Vrb having the polarity identical to the electrification polarity of the toner is applied to the restriction blade 46 (elastic member 462) having the conductivity. More generally, regarding the surface electrical potential of the toner layer transported onto the surface of the development roller 44, which is generated by the strong electrification toner carried on the surface of the development roller 44, it is desirable that the electrical potential in which the polarity is identical and the absolute value is larger than the surface electric potential of the toner layer transported onto the surface of the development roller 44 is applied to the restriction blade 46. In this point, the embodiments of the present invention is different from the technique described in JP-A-2005-331780 in which the electric charge is applied to the conductive toner before restricting the toner amount and the technique described in JP-A-2006-220967 in which an increase in the transport amount is expected to apply the conductive toner with the electric charge.

As described above, in this embodiment, as the external additives for improving the mobility, the silica having the particle diameter of 50 nm at the ratio of 0.5% by weight and the silica having the particle diameter of 12 nm at the ratio of 1% by weight are added to the toner base particles having the volume average particle diameter of 8 μm, and at the same time, in order to regulate the electrification property of the toner, toner to which the titanium oxide of the metal oxide external additive is added at the ratio of 1% by weight is used as the toner. Further, the metallic cylinder in which the regular unevenness is formed on the surface thereof by the rolling processing is used as the development roller 44, and at the same time the restriction blade 46 contacting the surface has the elastic member 462 by the conductive rubber and is applied with the restriction bias voltage Vrb.

With this structure, in this embodiment, the change in the electrification amounts of the toner carried on the surface of the development roller 44 is suppressed, and it is possible to form the image with an excellent image quality while suppressing the occurrence of the scattering and the fogging of the toner from the development roller 44.

Further, according to the experiments of the inventors, it was ascertained that when, in addition to the titanium oxide, the metal oxide-based the external additives, for example, aluminum oxide (in particular, succession alumina), zinc oxide, serum oxide and tin oxide and the like are used, the identical effects are obtained. In particular, when such external additives are added so that the coverage becomes larger than the external additives having high insulation property such as silica, the effect is remarkable. Further, regarding the insulation external additives such as silica or the like, the additive in which the particle diameter is smaller than the metal oxide-based external additives is not much of a problem, and the toner having larger particle diameter affects the electrification property of the toner. Thus, it is desirable to add the metal oxide-based external additives that are more than the insulation external additives having large particle diameters. In this embodiment, since the content of the silica external additives having a large particle diameter (50 nm) is 0.5% by weight, it is preferable that the metal oxide-based external additives be added in the amount that is at least identical to, more preferably, larger than the content. Further, since it is thought that even in the insulative external additives having small particle diameter, if the content is increased, the functions of the metal oxide-based external additives are deteriorated, it is preferable that the metal oxide-based external additives equal to or larger than the content be added. In this embodiment, the content of the titanium oxide having a particle diameter of 30 nm is 1% by weight so that the content is sufficiently larger than the large particle diameter silica (50 nm, 0.5% by weight) and is equal to the small particle diameter silica (12 nm, 1% by weight).

Further, it is ascertained that there is a difference in the effects also by the surface treatment of the development roller 44, and for example, in cases where the development roller 44 is made of steel, when the surface is subject to amorphous electroless plating treatment, excellent effects are obtained. As a preferable treatment, for example, there are a nickel-phosphorous plating treatment, a nickel-tungsten plating treatment, nickel-boron-tungsten plating treatment and chrome carbide plating treatment and the like. In the development roller in which the surface is covered with the amorphous material, it is considered that the frictional electrification of the toner by the friction with the supply roller 43 easily occurs, and since the electrification amount of the toner that is transported to the position contacting the restriction blade 46 is high, it was ascertained that the more efficient regulation of the electrification amount by the restriction bias voltage Vrb is possible.

Further, if, when the development roller 44 is made of aluminum, the surface is subject to alumite treatment, a thin insulation film is formed on the surface of the development roller 44, and therefore the insulation resistance between the development roller 44 and the restriction blade 46 can be increased, in particular, high insulation pressure resistant can be secured even in the toner having small particle diameter and the toner having large content of the carbon black pigment and high conductivity, while inhibiting current leaks, and it is possible to further increase the electrification amount of the toner with excellent control by the application of sufficient restriction bias voltage. This is effective in promoting the suppression of the scattering and the fogging in the small particle diameter or high pigment toner having a poor insulation property.

Further, according to the idea of the embodiments of the invention, the toner base particles themselves do not necessarily need the conductivity, in the viewpoint of suppressing the fogging, rather the toner base particles having low conductivity are advantageous in that the electrification control by the conductive external additives such as metal oxide is easy to perform. At this point, the toner may be used, which has been manufactured by a polymerization method capable of suppressing the conductivity to be low by covering the pigment with resin.

As described above, in this embodiment, the photosensitive body 22, the development roller 44 and the restriction blade 46 serve as “the latent image carrier”, “the toner carrying roller” and “the restriction blade” of the invention, respectively. Further, the developers 4Y, 4M, 4C and 4K provided with these correspond to “the development device” of the invention. In addition, the restriction bias power source 141 serves as the “bias application unit”.

Further, the invention is not limited to the above-described embodiments but various modifications can be made in addition to the above without departing from the gist. For example, while the embodiment is the so-called jumping development type of image forming device in which the photosensitive body 22 is opposed to the development roller 44 by the predetermined gap and the toner is flown therebetween, the present invention is applicable to the device in which alternating development bias is applied in a state where the photosensitive body 22 contacts the development roller 44.

Further, for example, while the convex portion 441 of the development roller 44 is formed almost in the diamond form, it is not limited thereto, for example the convex portion may have other shapes such as circles and triangles and the like. Further, the shape of each convex portion need not be identical, and other shapes may be mixed. However, in all cases, in order to obtain the effect to control the toner layer relating to the invention, it is desirable that at least the upper face of each convex portion be a constitution which each forms a portion of the cylinder surfaces identical to each other. Further, it is desirable that the depth of the concave portion be almost regular. At this point, it is particularly efficient that the unevenness is formed by engraving the concave portion onto the original flat cylinder surface.

Further, while the embodiments is directed at the color image forming device in which the developer 4K and the like is installed on the rotary development unit 4, the application subject of the invention is not limited thereto. For example, the present invention is applicable to the so-called tandem type color image forming device in which a plurality of developers are arranged along a middle transfer belt and a monochrome image forming device in which a monochrome image is formed by only one developer.

The entire disclosure of Japanese Patent Application No. 2009-070844, filed Mar. 23, 2009 is expressly incorporated by reference herein.

What is claimed is:

1. A development device comprising:
a housing having toner housed therein;
a toner carrying roller that is pivoted to the housing, with a plurality of convex portions that forms one portion of a cylindrical face in which each upper face is identical to each other and concave portions surrounding the convex portions formed on a surface thereof, and rotates while carrying the electrification toner supplied from the housing on the surface; and
a conductive restriction blade in which a free end faces the rotation direction upstream of the toner carrying roller and at the same time the free end or an adjoining region adjacent to the free end contacts the surface of the toner carrying roller, thereby restricting the amount of the toner carried on surface of the toner carrying roller,
wherein the toner has an external additive including a metal oxide, the restriction blade is applied with a restriction bias voltage of the same polarity as the regular electrification polarity of the toner, and a gap between the front end of the free end and the convex portion of the toner carrying roller is smaller than a volume average particle diameter of the toner.

2. The development device according to claim 1, wherein the gap between a front end of the free end and the convex portion of the toner carrying roller is zero.

3. The development device according to claim 1, wherein the toner includes at least one of titanium oxide, aluminum oxide, zinc oxide, cerium oxide or tin oxide, as the metal oxide.

4. The development device according to claim 1, wherein both contact toner that comes in direct contact with the toner carrying roller surface and non-contact toner that does not come in direct contact with the toner carrying roller surface are carried on the concave portion.

5. The development device according to claim 1, wherein the toner carrying roller is made of a metal in which the surface is subject to an amorphous plating treatment.

6. The development device according to claim 1, wherein the content of the metal oxide as the external additive in the toner is 0.5% by weight or more.

7. An image forming device comprising:
a housing having toner housed therein;
a toner carrying roller that is pivoted to the housing, with a plurality of convex portions that forms one portion of a cylindrical face in which each upper face is identical to each other and concave portions surrounding the convex portions formed on a surface thereof, and rotates while carrying the electrification toner supplied from the housing on the surface;
a conductive restriction blade in which a free end faces the rotation direction upstream of the toner carrying roller and at the same time the free end or an adjoining region adjacent to the free end contacts the surface of the toner carrying roller, thereby restricting the amount of the toner carried on surface of the toner carrying roller;
a bias applicator for applying a predetermined restriction bias voltage to the restriction blade; and
a latent image carrier that is arranged opposite to the toner carrying roller and carries an electrostatic latent image on a surface thereof;
wherein the toner has an external additive including a metal oxide, the restriction bias voltage has the same polarity as the regular electrification polarity of the toner, and a gap between a front end of the free end and the convex portion of the toner carrying roller is smaller than a volume average particle diameter of the toner.

8. An image forming method comprising:
carrying a toner on a surface of a toner carrying roller with a plurality of convex portions that form one portion of a cylindrical face in which each upper face is identical to each other and concave portions surrounding the convex portions formed on its surface;
contacting a conductive restriction blade in which a free end faces the rotating direction upstream of the toner carrying roller and at the same time the free end or an adjoining region adjacent to the free end contacts the toner carrying roller surface with the surface of the toner carrying roller, thereby restricting the amount of the toner; and
opposing a latent image carrier with an electrostatic latent image carried thereon to the toner carrying roller, thereby developing the electrostatic latent image by the toner,
the toner having an external additive including a metal oxide, the restriction blade being applied with the restriction bias voltage having the same polarity as the regular electrification polarity of the toner, and a gap between a front end of the free end and the convex portion of the toner carrying roller being smaller than a volume average particle diameter of the toner.
